(19) United States
(12) Patent Application Publication
(10) Pub. No.: US 2016/0332360 A1
(43) Pub. Date: Nov. 17, 2016

(54) METHOD FOR PRODUCING A FLEXIBLE CONTAINER HAVING A CLOSURE DEVICE

(71) Applicant: CELLPACK AG, Villmergen (CH)

(72) Inventor: Martin KROPF, Münchenbuchsee (CH)

(21) Appl. No.: 15/111,431

(22) PCT Filed: Jan. 30, 2015
(86) PCT No.: PCT/EP2015/051914

§ 371 Date: Jul. 13, 2016

(30) Foreign Application Priority Data
Feb. 3, 2014 (EP) 14153657.3

(51) Int. Cl. B29C 65/02; B65D 75/58; B29C 65/00; B29C 65/08; B29C 65/78

(52) U.S. Cl. CPC B29C 65/02; B29C 65/08; B29C 65/7841; B29C 66/81811; B65D 75/5883; B29L 2031/7128

(57) ABSTRACT

A weld-in part (1) is positioned between two film layers (12, 13) in the edge area of the latter and brought between a two-part tool (14, 15) whose tool parts (14, 15) are capable of being moved from an open position to a closed position substantially perpendicularly to the film layers (12, 13). The weld-in part (1) has a sealing region that is conical in longitudinal section, and the cross-sectional shape and the cone angle of the interior space of the closed tool (14, 15) correspond to the cross-sectional shape and the cone angle of the sealing region. After closing the tool (14, 15), the weld-in part (1) is moved parallel to the parting plane of the tool (14, 15) and brought into contact with the tool via the intermediate film layers (12, 13). In this manner, an accurate fit and a gapless enclosure of the parts that are to be connected (14, 15) is achieved in the tool independently of the dimensional tolerances of the weld-in part and of the film layers (12, 13).

The invention relates to a method according to the preamble of claim 1.

Flexible containers of this kind serve for receiving in particular liquid or pasty products, and the closure device includes a weld-in part having a through-going opening for dispensing the content of the container. The connection of the weld-in part to the film layers is achieved under the influence of heat whereby portions of the film layers and of the weld-in part are fused. To produce the required connection in the fused areas, pressure has to be applied to the latter and maintained for a certain time. Particularly important in this regard is the distribution of the pressure, whereby it is ensured that the resulting connection is tight, on one hand, and that the portions to be connected are not damaged or weakened, on the other hand. A particular problem in this regard is that the shape and the dimensions of the tools that are used are invariable whereas the shape and especially the dimensions of the portions to be connected vary within certain tolerances. Therefore the welding pressure built up in the closed tool will be variable and the result of the welding operation will necessarily be subject to considerable variations. If the weld-in part is too small and/or the film layers are too thin, the contact pressure in the area of the weld-in part will be insufficient, thereby resulting in an insufficient welding connection in this area. At the same time, in this situation, an excessive contact pressure and damages of the film layers may result in the areas adjacent to the weld-in part. If the weld-in part is too large, the latter or the overlying film layers may be damaged as a result of an excessive contact pressure whereas the areas of the film layers adjacent the weld-in part will not receive enough pressure and will be insufficiently welded.

According to a known method, the aforementioned problems are reduced by providing the weld-in part with salient ribs which melt off during the welding operation and fill potential gaps resulting from insufficient pressure. Similarly, the sealing tools also may be provided with surface structures in order to upset and distribute the material being welded. Another method consists in integrating elastic parts in the sealing tools in order to thus compensate for tolerances of the parts to be connected and to avoid excessive pressures in partial areas. A similar method is based on first applying one sealing jaw against an elastic support and then processing the opposite side. Combinations of the aforementioned methods have also been used.

One disadvantage of the known methods is that especially when ribs or the like are used, a sheet material has to be chosen that is more resistant and/or thicker than needed for the purposes of the package. Particularly in view of the current trend towards increasingly smaller packaging units and of the fact that sheet material manufacturers offer increasingly thinner packaging films which meet the requirements of the products to be packaged, using thicker sheets merely because of the welding connections represents a substantial waste. The methods that use elastic inlays or supports entail higher requirements in heat or time since the elastic materials are poor heat conductors.

On the background of this prior art it is an object of the invention to suggest a method for producing a flexible container having a closure device by which the weld-in part is safely welded in despite variations in the dimensions of the weld-in part and/or of the film layers due to series production.

This object is achieved by the measures specified in the characterising part of claim 1.

In particular, this inventive solution offers the advantage that the cross-sectional shape of the tool, which corresponds to the cross-sectional shape of the weld-in part, and the cone angle of the tool, which corresponds to the cone angle of the weld-in part, allow feeding the weld-in part to a position inside the tool where an accurate fit and a gapless enclosure of the parts that are to be connected is achieved in the tool independently of the dimensional tolerances of the weld-in part and of the film layers.

Particular embodiments of the method are described in the dependent claims.

Exemplary embodiments of the invention will be described by way of examples hereinafter with reference to the accompanying drawings showing

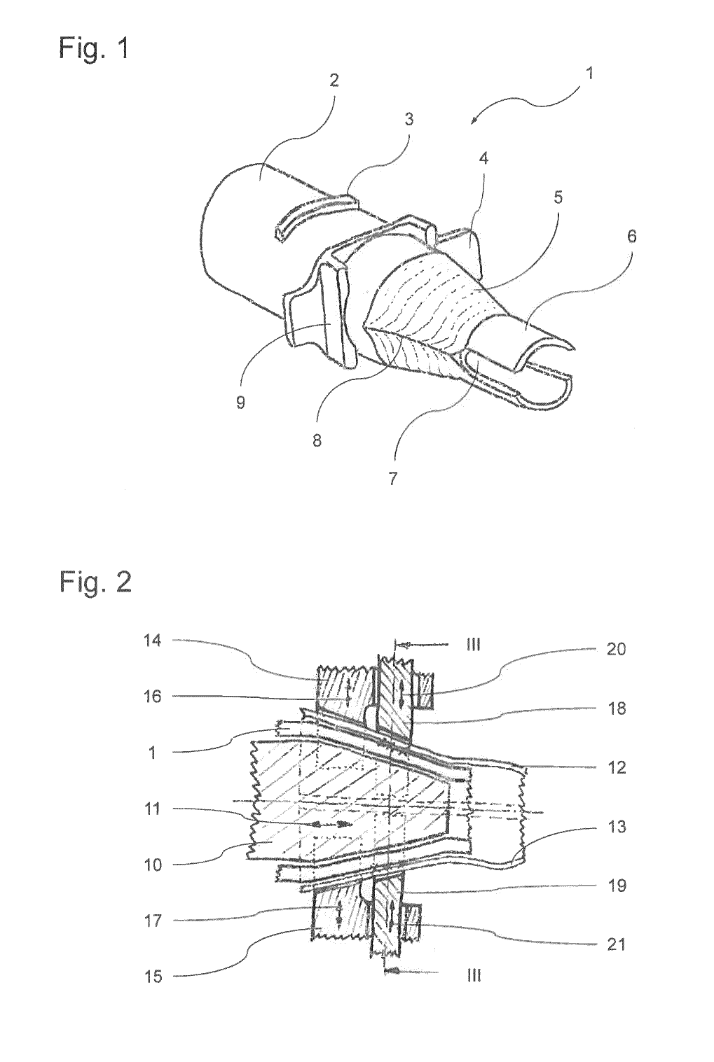

FIG. 1 a perspective view of a weld-in part that is suitable for the method of the invention;

FIG. 2 a longitudinal section through a tool with film layers and a weld-in part inserted therein; and

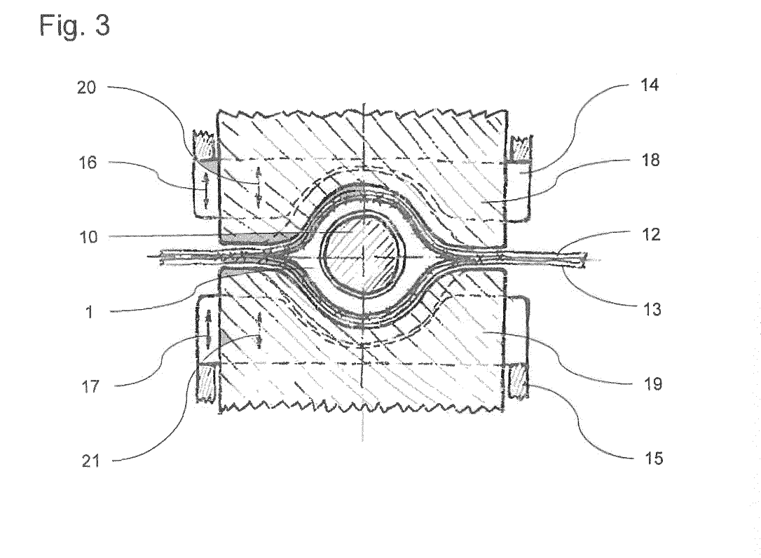

FIG. 3 a cross-section along line III-III in FIG. 2.

FIG. 1 shows a perspective view of a weld-in part 1 that has preferably been produced in one piece from a synthetic material by injection moulding. A tubular neck 2 with a through-going opening serves for dispensing the content of a flexible packaging container equipped with weld-in part 1. On the outside of the tubular neck, a thread section 3 is shown which serves as an engagement means for a cap that closes neck 2. A flange 4 with guide surfaces 9 may be provided in view of automatically processing weld-in part 1 or the finished welded container, respectively. A sealing region 5 is conically shaped as seen in longitudinal section. Basically, the cross-section of sealing region 5 may have any shape but it is preferably larger in the direction of the film layers than perpendicularly to the film layers. In the depicted example, fins 8 are formed laterally on the sealing region in order to promote a tight welding connection in the transition areas on both sides of weld-in part 1. An optional neck 6 may be provided at the free end of sealing region 5 and may have at least one slot 7 that is intended to facilitate the extraction of a liquid content.

FIG. 2 shows a longitudinal section of a tool assembly with a weld-in part 1 that is received between a front wall film 12 and a rear wall film 13 of a packaging pouch being manufactured, and in FIG. 3 the same assembly is shown in a sectional view along line III-III in FIG. 2.

Weld-in part 1 is positioned in the depicted position by a holding tool 14, 15. In the particular embodiment shown, the holding tool has a mandrel 10 that extends into the opening of weld-in part 1 and supports weld-in part 1 from the inside, which may be advantageous in the case of large weld-in parts. Also, in one embodiment, the mandrel may be made long enough to project from weld-in part 1 and thus serve as an inserting aid to position weld-in part 1 between film layers 12, 13. Ultimately, the mandrel may further be equipped with heating means to assist the welding operation. Likewise, mandrel 10 may be equipped with cooling means to allow the produced connections to be quickly cooled. Incidentally, the two film layers 12, 13 were brought into the depicted partly spread position by non-represented means, e.g. suction tools, in a preceding process step.

Two holding tool parts 14, 15 are movable towards each other in the direction of double arrows 16 and 17 from an open position to a closed position and inversely to an open position. When the holding tool parts 14, 15 are closed, they delimit a cavity whose cross-sectional geometry and cone angle exactly correspond to sealing region 5 of weld-in part 1. After closing the holding tool parts 14, 15, weld-in part 1 is moved to the right in FIG. 2 until it comes to lie via the intermediate sheets 12, 13 against holding tool parts 14, 15 without play. This state can e.g. be detected by a quick increase of the feeding force of the holding tool. Now an upper sealing tool part 18 and a lower sealing tool part 19 are moved towards each other in the direction of double arrows 20, 21, and sheets 12, 13 are welded to weld-in part at the locations marked by small crosses. Sealing tool 18, 19 may further be equipped with cooling means to allow the produced welding connections to be quickly cooled. Alternatively, the arrangement of holding tools 14, 15 and sealing tools 18, 19 shown in FIG. 2 may be reversed, i.e. sealing tools 18, 19 may be located closer to the edge of film layers 12, 13 than holding tools 14, 15.

Holding tool parts 14, 15 are provided with stops (not shown) which directly contact each other in the closed position without intermediate sheets 12, 13 and thus always define exactly the same interior space independently of the tolerances of weld-in part 1 and of sheets 12, 13. By inserting weld-in part 1 into this conical interior space until the parts to be connected are in close contact, the contact pressure applied to the closed tool parts can be controlled within very narrow limits.

Unlike the exemplary embodiment shown in FIGS. 2 and 3, it is not a requirement for the implementation of the method that the holding tools and the sealing tools are independent from each other. In fact, elements for generating or transmitting heat or vibrations and by which the welding operation is carried out may be integrated in tool pair 14, 15. As elements for generating heat, electric resistive heating elements may be provided. Elements for transmitting heat may e.g. be formed as channels conducting a fluid that is heated outside the tool. By vibrations, e.g. in the ultrasonic range, heat can be generated at the connections being produced. Cooling means may be arranged in the tool pair also in order to cool the produced welding connections and thus to accelerate the method. It is understood that the welding connections may alternatively be cooled in a subsequent step outside the described tools by separate cooling means.

Also, the direction of the conicity of sealing region 5 may be reversed relative to FIG. 2, i.e. the larger cross-section may be located in the interior of the container. Accordingly, in this embodiment, the weld-in part is brought into contact with the tool pair by traction before the welding operation starts.

In preparation of the operations described above, film layers 12, 13 may be tack-welded to weld-in part 1 e.g. by punctual welding connections in order to avoid that up to four elements, i.e. the two film layers 12, 13, weld-in part 1, and tool parts 14, 15, need to be positioned relative to one another.

Also in preparation of the aforementioned operations, film layers 12, 13 may be previously joined to each other by weld seams. In particular, a conical edge opening may be prepared whose cone angle is adapted to the cone angle of sealing region 5. In the final welding operation according to the method described above, the previously produced weld seams are then united with the newly produced weld seams in the transition areas.

Ultimately, profiled portions, e.g. in the form of ribs, may also be provided in the described method on the tool parts and/or in sealing region 5 of weld-in part 1 in order to improve the connection of the fused materials.

### LIST OF REFERENCE NUMERALS

1 weld-in part

2 tubular neck

3 thread section

4 flange

5 sealing region

6 neck

7 slot

8 fin

9 guide surface

10 mandrel

11 double arrow

12 front sheet

13 back sheet

14 upper holding tool part

15 lower holding tool part

16 double arrow

17 double arrow

18 upper sealing tool part

19 lower sealing tool part

20 double arrow

21 double arrow

1. Method for producing a flexible container having a closure device, the closure device comprising a weld-in part with a through-going opening, the weld-in part being positioned between two film layers in the edge area of the latter and brought between a two-part tool whose tool parts are capable of being moved from an open position to a closed position substantially perpendicularly to the film layers, and the weld-in part being connected to the film layers by the input of heat, wherein the weld-in part has a sealing region that is conical in longitudinal section, in that the cross-sectional shape and the cone angle of the interior space of the tool in its closed position correspond to the cross-sectional shape and the cone angle of the sealing region, and in that after closing the tool, the weld-in part is moved parallel to the parting plane of the tool.

2. Method according to claim 1, wherein the weld-in part is moved until it comes to lie against the tool via the intermediate film layers.

3. Method according to claim 2, wherein the movement of the weld-in part is stopped when a determined maximum contact pressure is reached.

4. Method according to claim 1, wherein a mandrel is placed in the opening of the weld-in part.

5. Method according to claim 4, wherein the mandrel is equipped with means for generating or transmitting heat or vibrations.

6. Method according to claim 5, wherein the mandrel is equipped with cooling means.

7. Method according to claim 1, wherein axially adjacent the tool another two-part tool is provided whose tool parts are capable of being moved independently of the tool from an open position to a closed position substantially perpendicularly to the film layers.

8. Method according to claim 7, wherein the tool or the further tool is equipped with means for generating or transmitting heat or vibrations.

9. Method according to claim 8, wherein the tool or the further tool is equipped with cooling means.

10. Method according to claim 1, wherein before being inserted into the tool (14, 15), the film layers (12, 13) are connected to the weld-in part (1) by punctual tack welds.

11. Method according to claim 1, wherein before positioning the weld-in part, the film layers are joined to each other in an area that corresponds to the contour of the weld-in part.
